(19) United States
(12) Patent Application Publication
(10) Pub. No.: US 2006/0220515 A1
(43) Pub. Date: Oct. 5, 2006

(54) Discharge light emitting device, light emitting apparatus, and method of manufacturing light emitting device

(76) Inventors: Tadashi Sakai, Kanagawa (JP); Tomio Ono, Kanagawa (JP); Naoshi Sakuma, Kanagawa (JP); Hiroaki Yoshida, Kanagawa (JP); Mariko Suzuki, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/223,029

(22) Filed: Sep. 12, 2005

(30) Foreign Application Priority Data
Mar. 30, 2005 (JP) 2005-100038

(51) Int. Cl. H01J 1/00; H01J 19/06

(52) U.S. Cl. 313/311

(57) ABSTRACT

A discharge light emitting device includes a container formed from insulating diamond and accommodating a discharge space therein, a material for discharge sealed in the discharge vessel, and an electrode pair formed from a conductive diamond and provided to apply voltage to the material for discharge.

### CROSS-REFERENCE TO RELATED APPLICATIONS

This application is based upon and claims the benefit of priority from the priority Japanese Patent Application No. 2005-100038, filed on Mar. 30, 2005; the entire contents of which are incorporated herein by reference.

### BACKGROUND OF THE INVENTION

1. Field Of The Invention

The present invention relates to a discharge light emitting device which emits light through discharge, a light emitting apparatus, and a method of manufacturing a light emitting device.

2. Description Of The Related Art

Conventionally known discharge lamps are light emitting devices utilizing gaseous plasma. Known such discharge lamps are, for example, mercury lamps and high pressure mercury lamps, and employed for various purposes, for example, as a hot cathode fluorescent ceiling lamp. Due to high luminous efficiency and high luminous output, the discharge lamps occupy approximately half the market share of lighting. Particularly, development of one type of discharge lamps called high intensity discharge (HID) lamps is notable in recent years (see E. Fisher: Proc. LS-8, p. 115 (2004), for example). The HID lamp drives high-pressure gas through electrical discharge which generates a high electric current to generate high-density plasma, thereby causing light emission.

The HID-type light source is applied to projectors, short arc lamps for automotive headlights, or the like. To employ the HID-type light source for such purposes, fixed focal length and a high output, as well as downsizing is required. Hence, the distance between electrodes for arc discharge is decreasing down to approximately one millimeter (mm).

To allow for application of electric power of a few ten to a few hundreds Watts (W) between the electrodes arranged at a small interval, the interior of the lamp is filled with high pressure mercury, metal halide, or the like. Hence, a vessel of the lamp is required to have a high strength as to endure the high internal pressure produced by the gas.

Conventionally, quartz is employed as a material of a lamp vessel which is required to exhibit resistance to high pressure. Quartz vessels, however, when filled with a high-pressure high-temperature activated gas, tend to be degraded through intake of active species into an inner wall, or the like. To eliminate such inconveniences, various translucent ceramics come to replace silica glass.

The translucent ceramics are excellent in stability against active species and exhibit higher resistance to heat. Though the translucent ceramics are now gaining popularity as a material for lamp vessels, still are not immune to problems such as corrosion at an interface with an internal electrode and pressure leakage. Further, an advanced sintering process employed for the manufacturing of the ceramic vessels, together with a mounting process of electrodes, contributes to push up the cost of light emitting apparatuses. Still further, along with the decreasing inter-electrode gap which in turn reduces fall of inter-electrode potential, power control is required to be lower in voltage and larger in electric current for the supply of same amount of power.

### SUMMARY OF THE INVENTION

According to one aspect of the present invention, a discharge light emitting device includes a container formed from insulating diamond and accommodating a discharge space therein, a material for discharge sealed in the discharge vessel, and an electrode pair formed from conductive diamond and provided to apply voltage to the material for discharge.

According to another aspect of the present invention, a discharge light emitting device, includes a translucent container in which a plurality of discharge vessels are arranged, a material for discharge sealed in each of the plurality of discharge vessels, and a plurality of electrode pairs each of which applies voltage to one of the plurality of discharge vessels.

According to still another aspect of the present invention, a discharge light emitting device includes a translucent container including a first low conductive layer and a second low conductive layer arranged as to face with each other, and a plurality of discharge vessels arranged between the first low conductive layer and the second low conductive layer, a material for discharge sealed in each of the plurality of discharge vessels, and a plurality of electrode pairs which apply voltage to the plurality of discharge vessels, respectively, and each includes a high conductive layer which exhibits a higher conductivity than the first low conductive layer and the second low conductive layer and is formed at a position where two of the plurality of discharge vessels are connected in series at least in a region of one of the first low conductive layer and the second low conductive layer.

According to still another aspect of the present invention, a light emitting apparatus according to the present invention; and a container accommodating the discharge light emitting device inside.

According to still another aspect of the present invention, a method of manufacturing a light emitting device includes: forming a plurality of penetrating holes which penetrate a first main surface and a second main surface of an insulating layer; filling the plurality of penetrating holes with a sacrifice layer; forming an electrode forming layer on each of the first main surface and the second main surface of the insulating layer in which the sacrifice layer is formed; forming an opening in a region corresponding to the sacrifice layer in the electrode forming layer formed on each of the first main surface and the second main surface; removing the sacrifice layer via the opening; sealing the opening after the removal of the sacrifice layer by formation of a conductive layer on the electrode forming layer, to form a discharge space which utilizes the conductive layer as electrode; and cutting a formed layered structure into a unit including the discharge vessel after the formation of the discharge vessel, to obtain the light emitting device.

### BRIEF DESCRIPTION OF THE DRAWINGS

FIG. 1 is a diagrammatic perspective view of a high-pressure discharge light emitting device according to a first embodiment of the present invention;

FIG. 2 is a vertical sectional view of the high-pressure discharge light emitting device according to the first embodiment of the present invention;

FIG. 3 is a diagrammatic perspective view of a polycrystalline translucent diamond substrate after formation of a plurality of holes;

FIG. 4 is a vertical sectional view of one of the plurality of holes formed in the polycrystalline translucent diamond substrate;

FIG. 5 is a vertical sectional view of a part of the polycrystalline translucent diamond substrate after formation of a first part of a first conductive diamond layer on a first main surface and a second conductive diamond layer on a second main surface;

FIG. 6 is a vertical sectional view of the polycrystalline translucent diamond substrate after formation of an opening;

FIG. 7 is a vertical sectional view of the polycrystalline translucent diamond substrate after formation of a second part of the first conductive diamond layer on the first main surface;

FIG. 8 is a diagrammatic perspective view of the single polycrystalline translucent diamond substrate in which the high-pressure discharge light emitting devices are formed;

FIG. 9 is a diagrammatic perspective view of a high-pressure discharge light emitting device according to a second embodiment;

FIG. 10 is a vertical sectional view of the high-pressure discharge light emitting device according to the second embodiment;

FIG. 11 is a vertical sectional view of the high-pressure discharge light emitting device after formation of a first insulating diamond layer on the first main surface according to the second embodiment;

FIG. 12 is a vertical sectional view of the high-pressure discharge light emitting device according to the second embodiment after further formation of a first conductive diamond layer on the first main surface;

FIG. 13 is a diagrammatic perspective view of a high-pressure discharge light emitting device according to a third embodiment;

FIG. 14 is a vertical sectional view of the high-pressure discharge light emitting device according to the third embodiment;

FIG. 15 is a vertical sectional view of the high-pressure discharge light emitting device according to the third embodiment after formation of the first conductive diamond layer on the first main surface and a second conductive diamond layer on the second main surface;

FIG. 16 is a diagrammatic perspective view of the high-pressure discharge light emitting device according to the third embodiment after formation of the first conductive diamond layer on the first main surface and the second conductive diamond layer on the second main surface;

FIG. 17 is a vertical sectional view of a high-pressure discharge light emitting device according to a fourth embodiment;

FIG. 18 is a vertical sectional view of the high-pressure discharge light emitting device according to the fourth embodiment after processing of a sacrifice layer;

FIG. 19 is a vertical sectional view of the high-pressure discharge light emitting device according to the fourth embodiment after formation of a first part of the first conductive diamond layer on the first main surface and a first part of the second conductive diamond layer on the second main surface;

FIG. 20 is a vertical sectional view of the high-pressure discharge light emitting device according to the fourth embodiment after formation of a first opening on the first main surface and a second opening on the second main surface;

FIG. 21 is a vertical sectional view of the high-pressure discharge light emitting device according to the fourth embodiment after further formation of a second part of the first conductive diamond layer on the first main surface and a second part of the second conductive diamond layer on the second main surface;

FIG. 22 is a vertical sectional view of a high-pressure discharge light emitting device according to a fifth embodiment;

FIG. 23 is a diagrammatic perspective view of a high-pressure discharge light emitting device according to a sixth embodiment;

FIG. 24 is a vertical sectional view of the high-pressure discharge light emitting device according to the sixth embodiment;

FIG. 25 is a vertical sectional view of the high-pressure discharge light emitting device according to the sixth embodiment after etching of the sacrifice layer and formation of the first conductive diamond layer on the first main surface and the second conductive diamond layer on the second main surface;

FIG. 26 is a diagrammatic perspective view of a high-pressure discharge light emitting device according to a first modification of the sixth embodiment;

FIG. 27 is a diagrammatic perspective view of a high-pressure discharge light emitting device according to a seventh embodiment;

FIG. 28 is a vertical sectional view of the high-pressure discharge light emitting device according to the seventh embodiment;

FIG. 29 is an explanatory diagram of an initial state of activation of the high-pressure discharge light emitting device according to the seventh embodiment;

FIG. 30 is an explanatory diagram of a state after start of discharge of the high-pressure discharge light emitting device according to the seventh embodiment;

FIG. 31 is a diagrammatic perspective view of a light emitting apparatus according to an eighth embodiment;

FIG. 32 is a diagrammatic perspective view of a light emitting apparatus according to a ninth embodiment; and

FIG. 33 is a diagrammatic perspective view of a light emitting apparatus according to a tenth embodiment.

### DETAILED DESCRIPTION OF THE PREFERRED EMBODIMENTS

In the following, exemplary embodiments of a discharge light emitting device, a light emitting apparatus, and a method of manufacturing the light emitting device according to the present invention will be described in detail with reference to the accompanying drawings. It should be noted that the present invention is not limited to the embodiments described below.

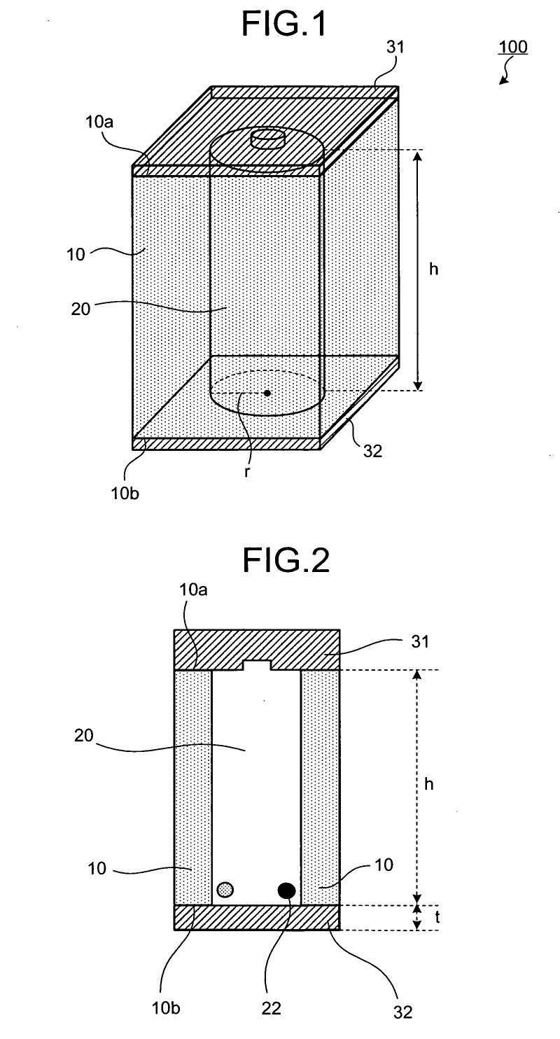

FIG. 1 is a diagrammatic perspective view of a high-pressure discharge light emitting device 100 according to a first embodiment. FIG. 2 is a vertical sectional view of the high-pressure discharge light emitting device 100. The high-pressure discharge light emitting device 100 includes an insulating diamond substrate 10 which is also referred to as a polycrystalline translucent diamond substrate hereinbelow, a discharge space 20 provided in the insulating diamond substrate 10, a first conductive diamond layer 31, and a second conductive diamond layer 32, the first and second conductive diamond layers serving as an electrode pair. The first conductive diamond layer 31 is formed on a first main surface 10a of the insulating diamond substrate 10, whereas the second conductive diamond layer 32 is formed on a second main surface 10b of the insulating diamond substrate 10.

The discharge vessel 20 encloses a material 22 for discharge. The material 22 is preferably mercury or metal compound. The metal compound is most preferably metal halide. Further, the metal halide is most preferably sodium iodide (NaI).

The insulating diamond substrate 10 is formed from polycrystalline diamond. The first conductive diamond layer 31 and the second conductive diamond layer 32 are diamond crystal doped with semiconductor impurity. Here, the semiconductor impurity is preferably phosphorous (P), nitrogen, or the like. Doping concentration is preferably equal to or higher than 1×10¹⁹, and less than 1×10²¹.

The height (h) of the insulating diamond substrate 10 according to the first embodiment is one millimeter (mm), and a radius (r) of the discharge space 20 is 300 micrometers (μm). The thickness (t) of the first conductive diamond layer 31 is preferably not less than 10 μm from a viewpoint of resistance to pressure in the discharge space 20.

Here, uniformly distributed weight applied onto the first conductive diamond layer 31 is calculated according to expression (1):

$${σ}_{max} = \frac{3}{4} {( \frac{r}{t} )}^{2} p \qquad ( 1 )$$

Here, p indicates pressure, and sₘₐₓ is maximum stress. The maximum stress is generated along the periphery.

Here, the pressure in the discharge space 20 is represented as:

200[atm]≈20[MPa].
When yield strength of diamond is assumed to be 20 GPa, maximum inverse aspect ratio can be calculated according to expression (2):

$$\frac{r}{t} \approx 36.5 . \qquad ( 2 )$$

Here, 200 atm is an upper limit of pressure when the discharge space 20 is filled with mercury (Hg). The yield strength of diamond is 53 GPa. However, the diamond in the first conductive diamond layer 31 includes impurity, and the strength of diamond crystal is known to vary according to the concentration of impurity. Hence, here the diamond is assumed to contain high-concentration nitrogen of an order of 100 ppm, and the yield strength of the first conductive diamond layer 31 is estimated to be 20 GPa.

When the radius (r) of the first conductive diamond layer 31 is 300 μm, the thickness (t) of the first conductive diamond layer 31 can be calculated according to expression (2) as expression (3):
300/36.5≈8.2 (3)

Hence, the thickness (t) is preferably sufficiently larger than 8.2 μm.

When the thickness (t) is 5 μm,
r<<36.5×5=182.5 (4)
and hence, the radius (r) is preferably sufficiently smaller than 182.5 μm.

The discharge space 20 is preferably designed so as to endure higher resistance up to twice the value illustrated above, i.e., up to 400 atm, under the ultrahigh pressure condition, for example, when the discharge space 20 is filled with Hg. Under such a circumstance, the radius (r) and the thickness (t) are designed so as to satisfy a relation represented by expression (5):

$$\frac{r}{t} ⪡ 25.8 \qquad ( 5 )$$

Hence, when the thickness is 5 μm, preferably the radius (r) is 129 μm.

Thus, the radius (r) and the thickness (t) of the first conductive diamond layer 31 are preferably designed so as to satisfy the relation between r and t (i.e., r/t) determined according to expression (1) based on the internal pressure of the discharge space 20.

Thus, being formed of the insulating diamond substrate 10, the high-pressure discharge light emitting device 100 according to the first embodiment can resist high-pressure of the discharge space 20. In other words, the high-pressure discharge light emitting device 100 has very good safety and can emit high power light.

Table 1 shows thermal conductivity and the like of alumina and CVD diamond.

TABLE 1

| | thermal | yield | specific | |
|---|---|---|---|---|
| | conductivity | strength | heat | specific |
| material | (W/m · K) | (GPa) | (kJ/kg · K) | gravity |
| Alumina | 17 | 0.3 | 0.8 | 3.52 |
| CVD diamond | 1000 | 1.0 | 0.51 | 3.60 |

Thus, since diamond has a high thermal conductivity, temperature in the discharge space can be maintained more uniformly. In addition, the temperature can be easily controlled.

Still further, since diamond has a high specific strength, necessary layer thickness can be reduced. Then, the loss of light can be suppressed at light emission to outside. In addition, luminance as well as the stability of the emitted light can be increased.

Still further, the reduction in the layer thickness can bring about the reduction in heat capacity. Then, the thermal responsiveness is improved to reduce the time required for the temperature rise after the start of the discharge.

One of the indicators to evaluate the thermal responsiveness is time constant. Time constant can be calculated according to expression (6):
Time Constant=Thermal Resistance of Object to Environment×Heat Capacitance (6)

The heat capacity can be calculated according to expression (7):
Heat Capacity=Volume×Specific Heat×Weight Volume Ratio (7)

According to Table 1, the ratio of strength of diamond to alumina is 10:3. Hence, the thickness of the wall of the discharge space is estimated to be 1:3. In other words, the ratio of volume is estimated to be 1:3. The ratio of specific heat is, then, approximately 0.51/0.8, i.e., approximately 0.64, and the ratio of weight volume ratio is 3.6/3.52, i.e., approximately 1.0. Then, the ratio of thermal capacity is approximately 0.2.

Thus, when the thermal resistance of the object to environment is the same, the time constant of diamond is one fifth that of alumina. Thus, when diamond is employed as a material, thermal responsiveness can be improved.

Further, the first conductive diamond layer 31 and the second conductive diamond layer 32 are both made from conductive diamond and serve as the electrode pair. When the same material as employed for the insulating wall portion is employed for the layers closing the discharge space, erosion at the interface and the leakage, which are attributable to the difference in coefficient of thermal expansion and chemical stability of the materials, can be suppressed.

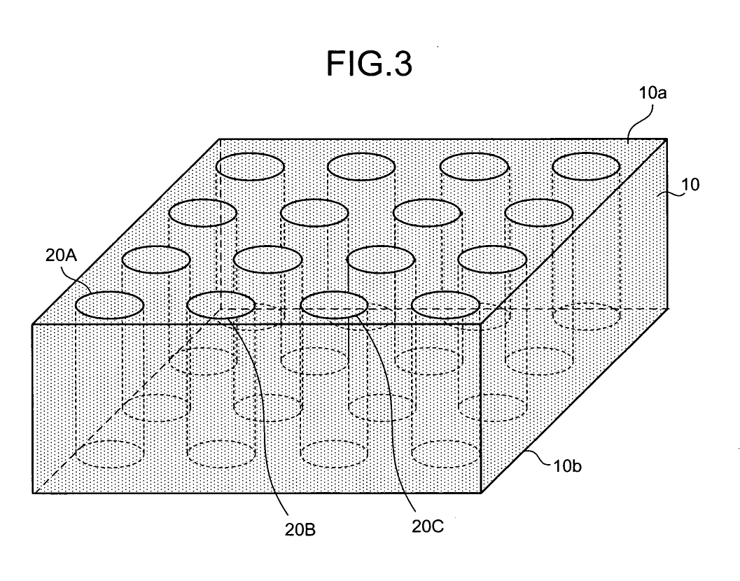

Next, a method of manufacturing the high-pressure discharge light emitting device 100 will be described with reference to FIGS. 3 to 8. The polycrystalline translucent diamond substrate 10 is employed as a substrate. The thickness of the substrate is 1 mm. For the growth of diamond, methane and hydrogen are employed and micro plasma chemical vapor deposition (CVD) is utilized.

Alternatively, direct current plasma CVD, combustion flame plasma CVD, hot filament CVD, and other various techniques can be employed.

First, a hole, which will later become the discharge space 20, is formed in the polycrystalline translucent diamond substrate 10. The hole is 300 μm in radius. The hole is formed preferably with laser such as YAG laser. Further, the substrate is preferably irradiated with laser while being rotated. Alternatively, the hole can be formed by dry etching.

FIG. 3 is a view of the polycrystalline translucent diamond substrate 10 after the hole formation. As can be seen from FIG. 3, a plurality of holes 20A, 20B, . . . , are formed in the polycrystalline translucent diamond substrate 10. These holes 20A, 20B, . . . , respectively later become discharge spaces 20A, 20B, . . . . Thus, from the single polycrystalline translucent diamond substrate 10, the plurality of high-pressure discharge light emitting devices 100 are manufactured at the same time. The insulating diamond substrate 10 is later divided to produce plural high-pressure discharge light emitting devices 100. In other words, a plurality of discharge spaces and electrode pairs are formed from the same insulating diamond substrate 10, and thus this method can provide low cost, consistent quality manufacturing.

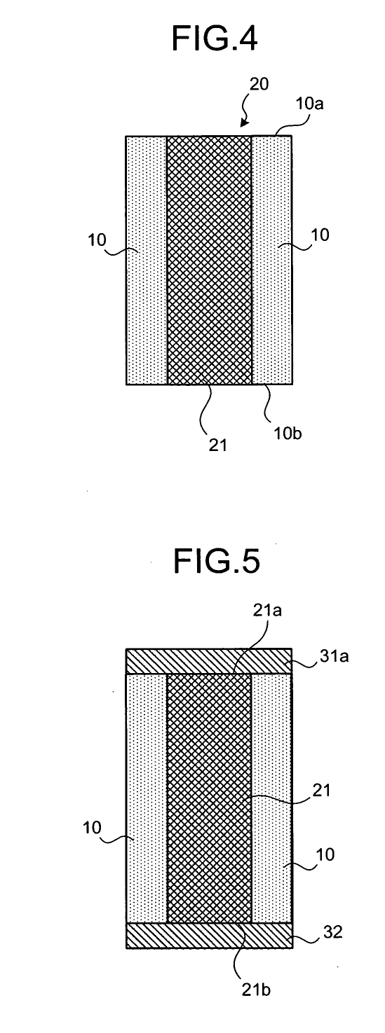

After the formation of all holes 20A, 20B, . . . , all holes 20A, 20B, . . . are filled with a sacrifice layer 21. Here, metal or the like are preferably employed for the sacrifice layer 21. In the first embodiment, molybdenum (Mo) is deposited from one side or both sides of the substrate. Then, a remnant portion which extends beyond the area of the insulating diamond substrate 10 is removed via etching or polishing. FIG. 4 is a vertical sectional view of one of the holes 20A, 20B, . . . , formed in the polycrystalline translucent diamond substrate 10. The hole 20 is filled with the sacrifice layer 21.

Then, the conductive diamond layers are formed on respective sides of the polycrystalline translucent diamond substrate 10 via CVD. Specifically, the first conductive diamond layer 31 and the second conductive diamond layer 32 are formed respectively on a first main surface 21a and a second main surface 21b of the sacrifice layer 21. FIG. 5 is a vertical sectional view of a part of the polycrystalline translucent diamond substrate 10 after the formation of the first conductive diamond layer 31a and the second conductive diamond layer 32.

For granting conductivity, the formed layers are doped with the semiconductor impurity. Specifically, n-type impurity such as phosphorous or nitrogen is desirable dopant. The doping concentration is preferably not less than 1×10¹⁹. Further, the doping concentration is preferably less than 1×10²¹.

The conductive diamond layer is formed to a sufficient thickness together with other eventually formed layers as to be able to resist internal pressure. The thickness of the conductive diamond layer is preferably 10 μm as mentioned above.

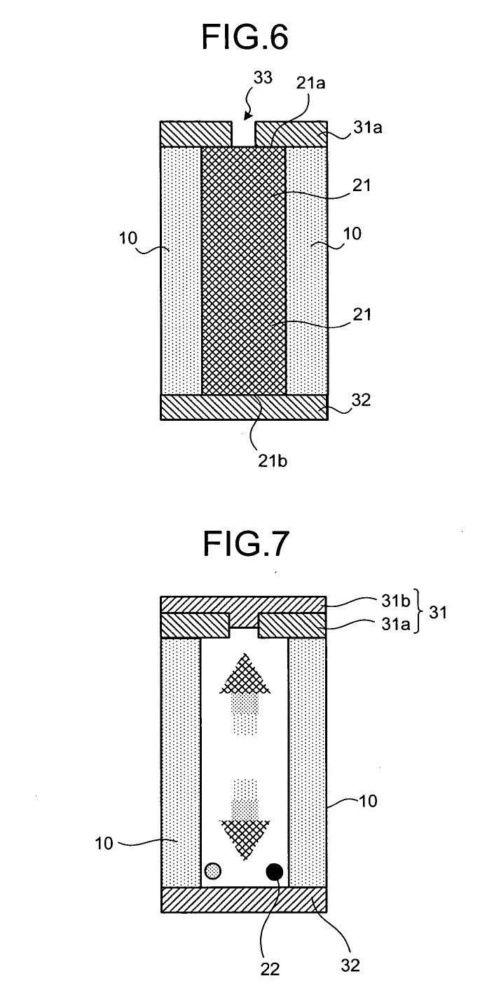

After the formation of a first part 31a of the first conductive diamond layer 31 and the second conductive diamond layer 32 to enclose the first main surface 21a and the second main surface 21b of the sacrifice layer 21, an opening 33 is formed at least on a part of the first part 31a of the first conductive diamond layer 31 that contacts with the first main surface 21a. The opening 33 is preferably formed via etching or the like. FIG. 6 is a vertical sectional view after the formation of the opening 33.

Then, through the etching of the sacrifice layer 21 via the opening 33, the interior of the discharge space 20 is hallowed. To achieve etching of the interior of the discharge space 20 to a sufficient level, the first part 31a of the first conductive diamond layer 31 and the second conductive diamond layer 32 are preferably processed as to have a plurality of holes, thereby facilitating the circulation of etching liquid. The opening 33 may be formed in any size or position as far as the opening 33 is formed as to face with the sacrifice layer 21. For example, the opening 33 may be formed on the second conductive diamond layer 32. Alternatively, two openings 33 may be formed on the first part 31a of the first conductive diamond layer 31. Further, one opening 33 may be formed in each of the first conductive diamond layer 31 and the second conductive diamond layer 32.

After introduction of pellet containing metal compound, mercury or the like into the interior of the discharge space 20 from the opening 33, the opening 33 is closed. Specifically, a second part 31b of the first conductive diamond layer 31 is formed further on the first part 31a of the first conductive diamond layer 31 in which the opening 33 is formed. FIG. 7 is a vertical sectional view after the formation of the second part 31b of the first conductive diamond layer 31. In the first embodiment, the first part 31a of the first conductive diamond layer 31 and the second conductive diamond layer 32 are formed through CVD. Similarly, the second part 31b of the first conductive diamond layer 31 is formed through CVD to close the opening 33. In the process of CVD, base gas may be filled into the discharge space 20 along with the deposition at high pressure utilizing rare gas such as Argon (Ar), xenon (Xe) or the like as base gas.

In the first embodiment, the opening 33 is closed by the further deposition of the second part 31b of the first conductive diamond layer 31. Alternatively, other various materials which can be formed at lower temperatures may be employed.

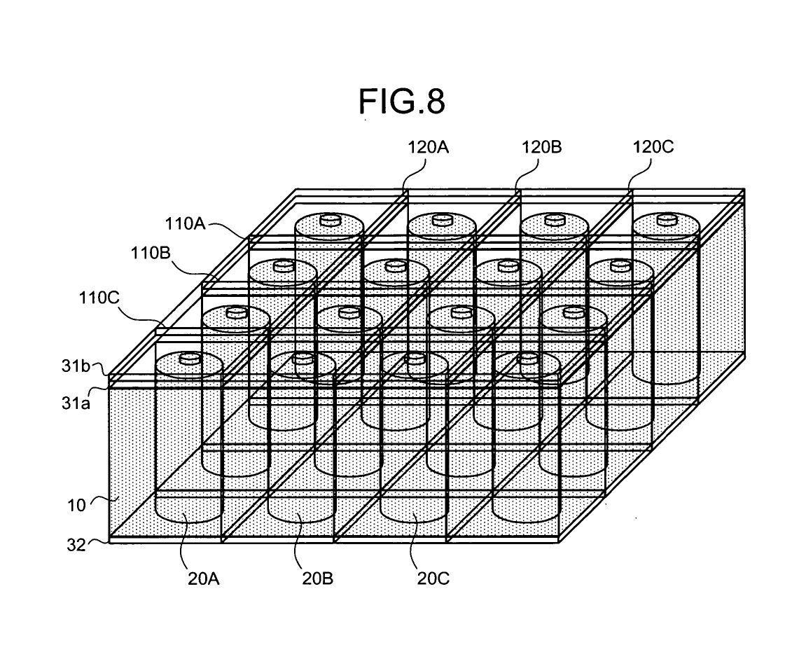

Through the above-described process, the plurality of high-pressure discharge light emitting devices 100 are formed in the single polycrystalline translucent diamond substrate 10. FIG. 8 shows the single polycrystalline translucent diamond substrate 10 in which the high-pressure discharge light emitting devices 100 are formed. The single polycrystalline translucent diamond substrate 10 may be subjected to further processing such as polishing as necessary on an upper and a lower electrode surfaces, i.e., at the first conductive diamond layer 31 and the second conductive diamond layer 32, for the production of planarized devices with uniform fine surface structure. The single polycrystalline translucent diamond substrate 10 on a wafer is divided along dividing lines 110A-110C, 120A-120C via laser processing or the like, and etching, polishing, washing or the like are performed as necessary on edge surfaces. Through the above-described processing, the high-pressure discharge light emitting device 100 as shown in FIGS. 1 and 2 is obtained.

Hereinabove, the first embodiment of the present invention is described. The first embodiment can be modified or improved in various ways.

As a first modification, the method of manufacturing according to the first embodiment may be applied to manufacturing of light emitting devices of materials other than diamond. For example, the above method can be applied to manufacturing of light emitting devices of translucent ceramics.

As a second modification, the high-pressure discharge light emitting device 100 may be columnar. In this case, each of the high-pressure discharge light emitting device 100 is cut out from the insulating diamond substrate 10 in a columnar shape in a final process of the manufacturing. Thus, the external shape of the insulating diamond substrate 10 is not limited to the rectangular columnar shape as shown according to the first embodiment.

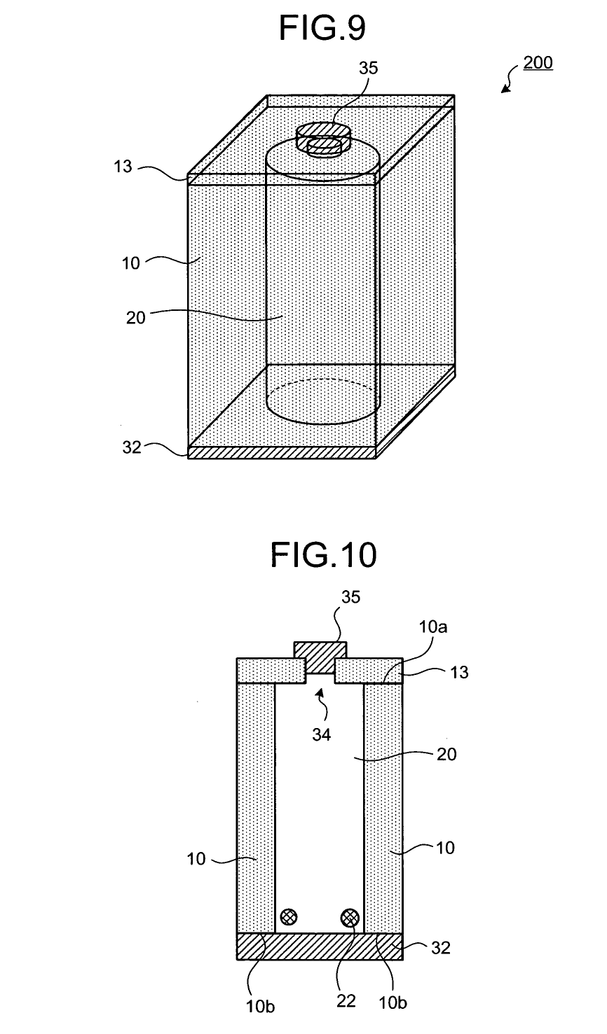

FIG. 9 is a diagrammatic perspective view of a high-pressure discharge light emitting device 200 according to a second embodiment. FIG. 10 is a vertical sectional view of the high-pressure discharge light emitting device 200 according to the second embodiment. In the high-pressure discharge light emitting device 200 according to the second embodiment, a first conductive diamond layer 35 is formed as an electrode only in the vicinity of the opening 33.

In the high-pressure discharge light emitting device 200 according to the second embodiment, a first insulating diamond layer 13 is formed further on the first main surface 10a of the insulating diamond substrate 10. The first insulating diamond layer 13 is formed from the insulating diamond similarly to the isulating diamond substrate 10. A first opening 34 in the first main surface is formed in the first insulating diamond layer 13. The first conductive diamond layer 35 is formed on the first main surface in a position corresponding to the first opening 34 and closes the opening 34.

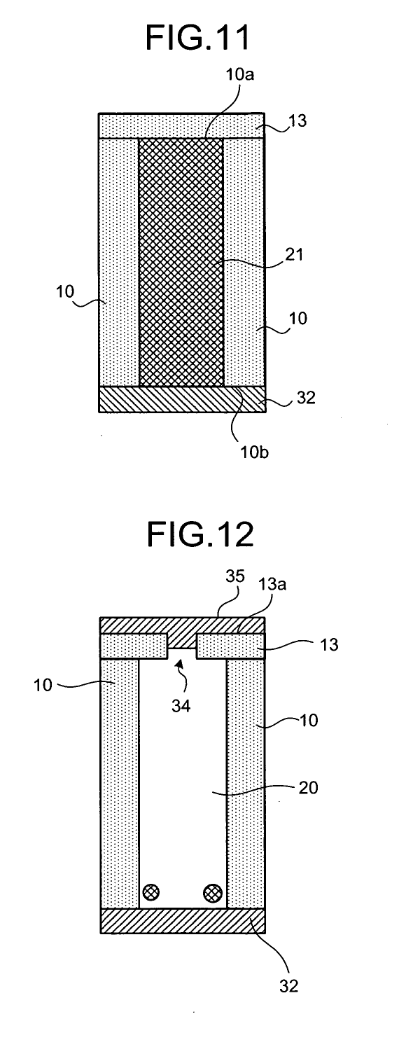

A method of manufacturing the high-pressure discharge light emitting device 200 according to the second embodiment is described. In the high-pressure discharge light emitting device 200 according to the second embodiment, the first insulating diamond layer 13 is formed on the first main surface 10a of the polycrystalline translucent diamond substrate 10 after the formation of holes and the filling of the sacrifice layer. Further, the second conductive diamond layer 32 is formed on the second main surface 10b of the polycrystalline translucent diamond substrate 10. FIG. 11 is a vertical sectional view after the formation of the first insulating diamond layer 13.

Then, the first opening 34 is formed in the first insulating diamond layer 13 and the sacrifice layer 21 is removed via etching. Thereafter, the first conductive diamond layer 35 is formed on the main surface 13a of the first insulating diamond layer 13. Thus, the first opening 34 is closed. FIG. 12 is a vertical sectional view after the formation of the first conductive diamond layer 35. Further, the first conductive diamond layer 35 is etched so as to leave a portion above the first opening 34.

The conductive diamond is low in the degree of transparency compared with the insulating diamond since the conductive diamond is doped with impurity. Hence, for the suppression of light loss caused at the light emission to outside, an area occupied by the conductive diamond is desirably minimized. In the second embodiment, the first conductive diamond layer 35 is formed only above the first opening 34 as described above. Thus, the light loss at the light emission to the outside can be suppressed.

The structure and the method of manufacturing of the high-pressure discharge light emitting device 200 according to the second embodiment are same with those of the high-pressure discharge light emitting device 100 according to the first embodiment when not specifically mentioned otherwise.

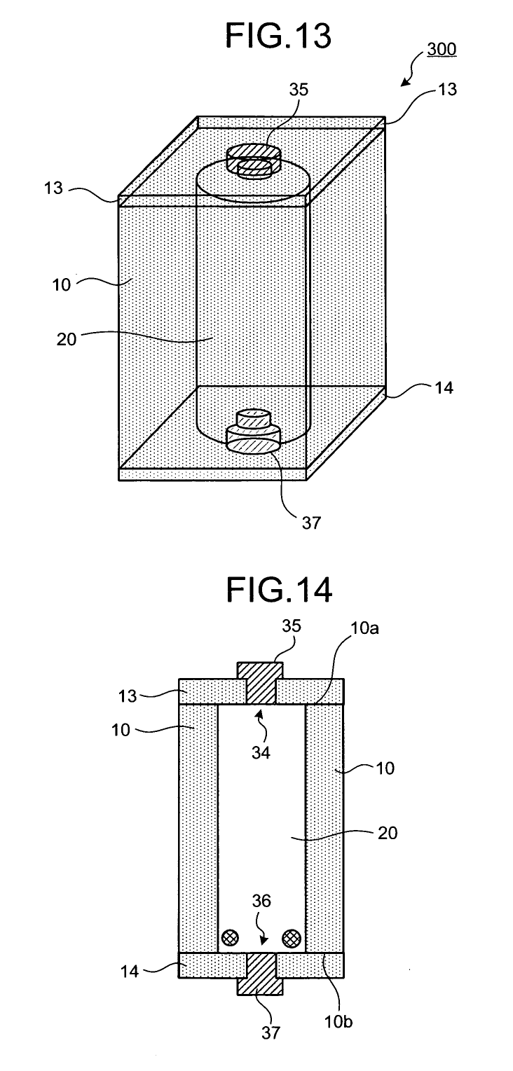

FIG. 13 is a diagrammatic perspective view of a high-pressure discharge light emitting device 300 according to a third embodiment. FIG. 14 is a vertical sectional view of the high-pressure discharge light emitting device 300 according to the third embodiment. The high-pressure discharge light emitting device 300 according to the third embodiment includes the first insulating diamond layer 13 on the first main surface 10a of the insulating diamond substrate 10. In the first insulating diamond layer 13, the first opening 34 is formed. In the first opening 34, the first conductive diamond layer 35 is formed to close the first opening 34.

On the other hand, a second insulating diamond layer 14 is formed on the second main surface 10b of the insulating diamond substrate 10. In the second insulating diamond layer 14, a second opening 36 is formed. In the second opening 36, the second conductive diamond layer 37 is formed to close the second opening 36.

Thus, the high-pressure discharge light emitting device 300 according to the third embodiment has a smaller area of conductive diamond on both surfaces of the insulating diamond substrate 10. Thus, the light loss at the light emission to the outside can be further reduced.

A method of manufacturing the high-pressure discharge light emitting device 300 according to the third embodiment is described. In the high-pressure discharge light emitting device 300 according to the third embodiment, after the formation of holes in the insulating diamond substrate 10 and the filling of the sacrifice layer 21, the first opening 34 and the second opening 36 are respectively formed on the first main surface 10a and the second main surface 10b of the insulating diamond substrate 10.

Then, the sacrifice layer 21 is removed from the first opening 34 and the second opening 36, and pellet containing metal compound, mercury (Hg) or the like is introduced into the discharge space 20 for the formation of high-pressure gaseous plasma.

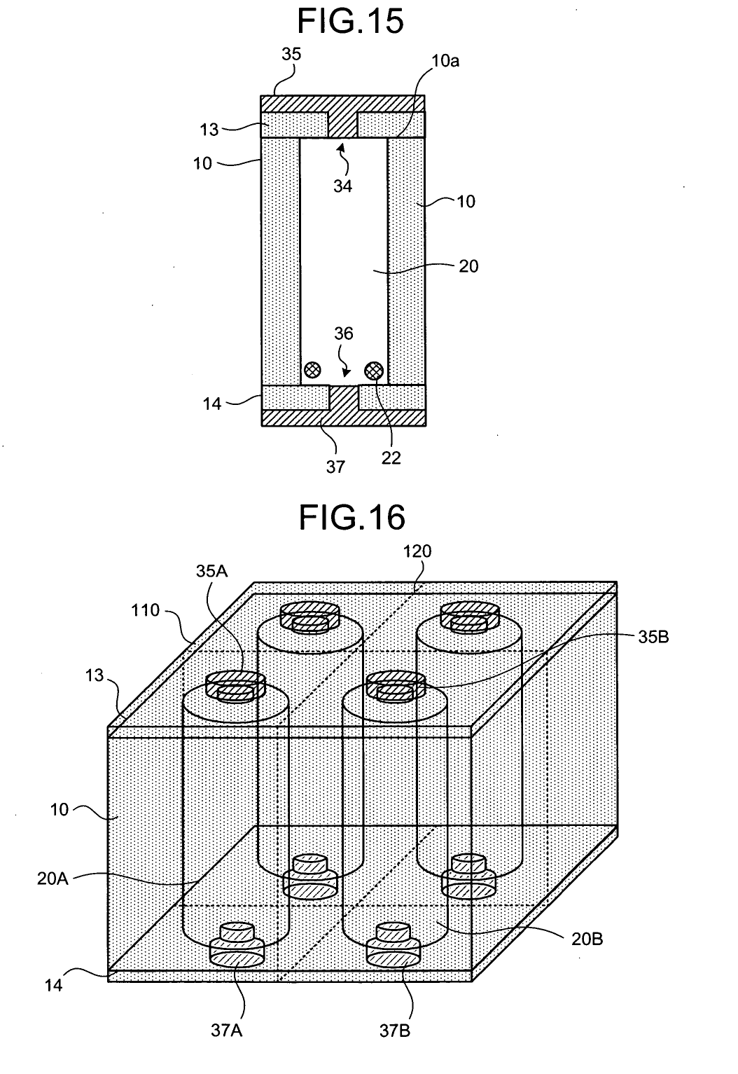

Then, the first conductive diamond layer 35 and the second conductive diamond layer 37 are formed respectively on the first insulating diamond layer 13 on the first main surface 10a and the second insulating diamond layer 14 on the second main surface 10b. Thus, the discharge space 20 is enclosed. FIG. 15 is a vertical sectional view after the formation of the first conductive diamond layer 35 and the second conductive diamond layer 37.

Then, the first conductive diamond layer 35 and the second conductive diamond layer 37 are subjected to patterning, so as to leave only a necessary region of the first conductive diamond layer 35 and the second conductive diamond layer 37 to close the discharge space 20. FIG. 16 is a diagrammatic perspective view after the formation of the first conductive diamond layer 35 and the second conductive diamond layer 37. Thereafter, the polycrystalline translucent diamond substrate 10 is divided into portions each include the discharge space 20, whereby the plurality of the high-pressure discharge light emitting devices 300 are formed.

The first conductive diamond layer 35 and the second conductive diamond layer 37 surely serve as electrodes facing the discharge space 20. In addition, when an area of the conductive region, in other words, a region with low degree of transparency is minimized, the light loss at the light emission to the outside can be minimized.

Further, when the conductive electrode region is formed to provide an internal discharge electrode only in a necessary central region for the high-density plasma formation after the formation of a pressure vessel with a large inner diameter with the insulating diamond substrate and the diamond layer, the interaction between the plasma convergence and the side wall can be reduced.

The structure and the method of manufacturing the high-pressure discharge light emitting device 300 according to the third embodiment are same with those of the high-pressure discharge light emitting device according to other embodiments when not specifically mentioned otherwise.

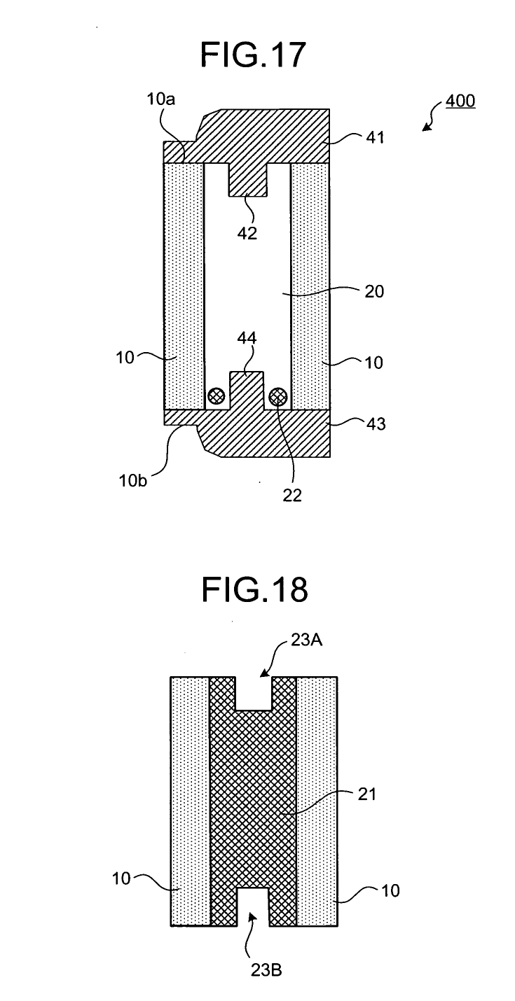

FIG. 17 is a vertical sectional view of a high-pressure discharge light emitting device 400 according to a fourth embodiment. The high-pressure discharge light emitting device 400 according to the fourth embodiment includes a first protrusion 42 on the first main surface 10a and the first protrusion 42 protrudes towards the discharge space 20. Similarly, a second conductive diamond layer 43 includes a second protrusion 44 on the second main surface 10b and the second protrusion 44 protrudes towards the discharge space 20. With such a structure where the conductive diamond layers are protruding towards the interior of the discharge space 20, the point of discharge can be controlled through the adjustment of the height of the first conductive diamond layer 41 and the first protrusion 42 regardless of the dimension, i.e., the internal diameter or the height of the discharge space 20.

Next, a method of manufacturing the high-pressure discharge light emitting device 400 according to the fourth embodiment is described. In the high-pressure discharge light emitting device 400 according to the fourth embodiment, after the filling of the sacrifice layer 21, the sacrifice layer 21 is processed so as to be depressed in part from the level of the surface of the insulating diamond substrate 10. FIG. 18 is a vertical sectional view after the processing of the sacrifice layer 21. In the processing of the sacrifice layer 21, a first depression 23A on the first main surface 10a and a second depression 23B on the second main surface 10b are formed as shown in FIG. 18.

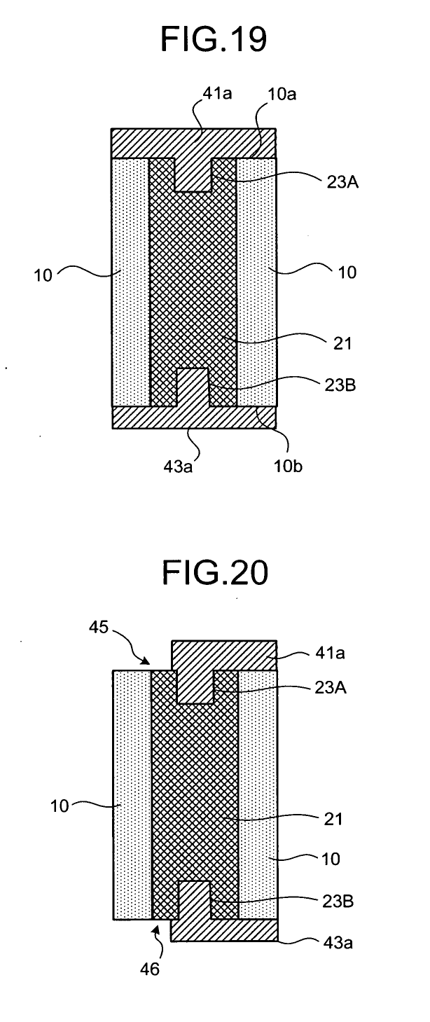

Then, a first part 41a of a first conductive diamond layer 41 is formed on the first depression 23A and on the first main surface 10a. Similarly, a first part 43a of a second conductive diamond layer 43 is formed on the second depression 23B and on the second main surface 10b. FIG. 19 is a vertical sectional view after the formation of the first part 41a of the first conductive diamond layer 41 and the first part 43a of the second conductive diamond layer 43.

Then, a first opening 45 is formed on the first main surface 10a in the first part 41a of the first conductive diamond layer 41. Here, the first opening 45 is formed in a region other than a portion above the first depression 23A. Similarly, a second opening 46 is formed on the second main surface 10b in the first part 43a of the second conductive diamond layer 43. FIG. 20 is a vertical sectional view after the formation of the first opening 45 and the second opening 46.

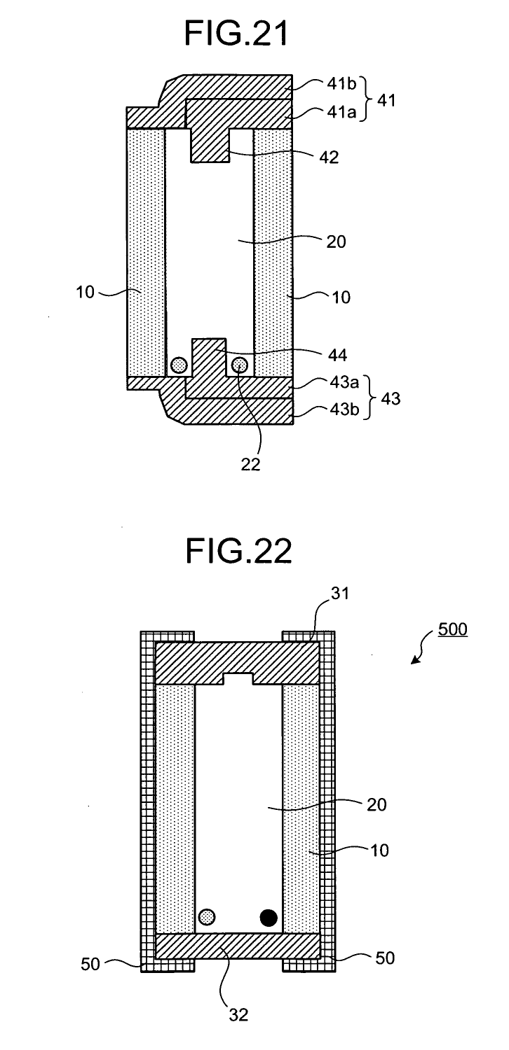

Then, the sacrifice layer 21 is removed via etching. Thereafter, a second part 41b of the first conductive diamond layer 41 is further formed above the first opening 45 and the first part 41a of the first conductive diamond layer 41. Similarly, a second part 43b of the second conductive diamond layer 43 is formed on the second opening 46 and the first part 43a of the second conductive diamond layer 43. FIG. 21 is a vertical sectional view after the formation of the second part 41b of the first conductive diamond layer 41 and the second part 43b of the second conductive diamond layer 43. Thus, the high-pressure discharge light emitting device 400 according to the fourth embodiment as described with reference to FIG. 17 is formed.

The structure and the method of manufacturing the high-pressure discharge light emitting device 400 according to the fourth embodiment are same with those of the high-pressure light emitting device according to other embodiments when not specifically mentioned otherwise.

FIG. 22 is a vertical sectional view of a high-pressure discharge light emitting device 500 according to a fifth embodiment. The high-pressure discharge light emitting device 500 according to the fifth embodiment includes a protective layer 50 outside the insulating diamond substrate 10. The protective layer 50 covers the insulating diamond substrate 10, the first conductive diamond layer 31, the second conductive diamond layer 32, other than areas to be utilized as electrodes. The protective layer 50 is formed of silicon nitride (Si₃N₄). Alternatively, the protective layer 50 may be formed of silicon carbide (SiC) , alumina (Al₂O₃) or the like. The protective layer 50 is preferably formed of a material which has resistance to oxidization at high temperatures.

With the provision of the protective layer 50, the oxidization of the insulating diamond substrate 10 can be prevented. In turn, the degradation of the high-pressure discharge light emitting device 500 can be prevented. In addition, the protective layer 50 serves as heat insulator.

The structure and the method of manufacturing the high-pressure discharge light emitting device 500 according to the fifth embodiment are same with those of the high-pressure discharge light emitting device according to other embodiments when not specifically mentioned otherwise.

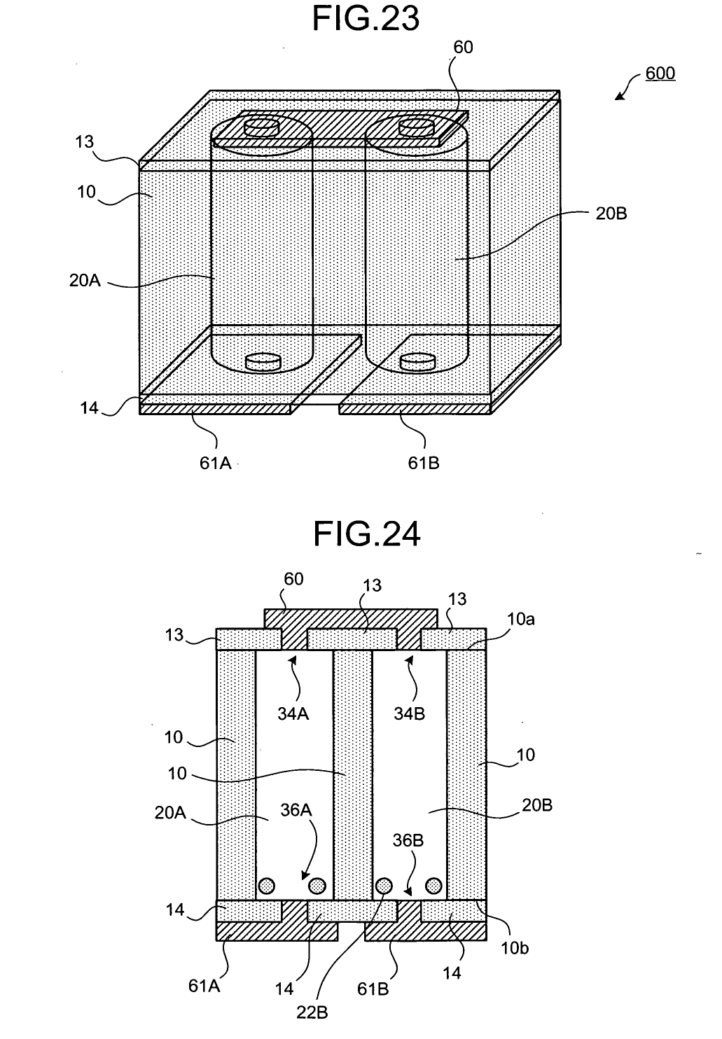

FIG. 23 is a diagrammatic perspective view of a high-pressure discharge light emitting device 600 according to a sixth embodiment. FIG. 24 is a vertical sectional view of the high-pressure discharge light emitting device 600 according to the sixth embodiment. The high-pressure discharge light emitting device 600 according to the sixth embodiment includes two discharge spaces 20A and 20B. The first insulating diamond layer 13 is formed on the first main surface 10a. In the first insulating diamond layer 13, a first opening 34A is formed at the side of the first main surface 10a in a position corresponding to the discharge space 20A. Further, a second opening 34B is formed at the side of the first main surface 10a in a position corresponding to the discharge space 20B. On the other hand, the second insulating diamond layer 14 is formed on the second main surface 10b. In the second insulating diamond layer 14, a third opening 36A is formed at the side of the second main surface 10b in a position corresponding to the discharge space 20A. Further, a fourth opening 36B is formed at the side of the second main surface 10b in a position corresponding to the discharge space 20B.

A first conductive diamond layer 60 is formed above the insulating diamond layer 13 on the first main surface 10a. The first conductive diamond layer 60 is provided as to close the first opening 34A and the second opening 34B on the first main surface 10a. Further, the first conductive diamond layer 60 is formed integrally from the region of the first opening 34A to the region of the second opening 34B.

A first part 61A and a second part 61B of a second conductive diamond layer 61 are formed above the second insulating diamond layer 14 on the second main surface 10b. The first part 61A of the second conductive diamond layer 61 is formed as to close the third opening 36A on the second main surface 10b. Further, the second part 61B of the second conductive diamond layer 61 is formed as to close the fourth opening 36B. The first part 61A of the second conductive diamond layer 61 and the second part 61B of the second conductive diamond layer 61 are provided separately in an area over the region of the third opening 36A and the fourth opening 36B.

In the above-described structure, when electrodes are provided respectively at positions corresponding to the third opening 36A and the fourth opening 36B, the electric current flows from the discharge space 20A and through the first conductive diamond layer 60 to the electrode provided in the discharge space 20B.

Thus, when the plurality of discharge spaces 20 are formed in one chip, even though respective discharge spaces 20 are arranged in small intervals, the discharge space 20A and the discharge space 20B are connected in series, and the voltage applied to the plural discharge spaces can be maintained high. Further, when the applied voltage is maintained at a high level, the high power, i.e., high light intensity can be secured without further supply of high electric current.

Further, as shown in FIGS. 23 and 24, two discharge spaces 20A and 20B are arranged so that the electrode pair of each discharge space is formed on a same plane as the first conductive diamond layer 60 and the second conductive diamond layer 61. In other words, the two discharge spaces 20A and 20B are arranged so that they are parallel with the insulating diamond substrate 10. Hence, the discharge spaces can function as a single light source.

Alternatively, composition of the compound to be introduced into each discharge space 20 may differ from each other. Then, light control can be realized with combination of different light emission caused by different compounds.

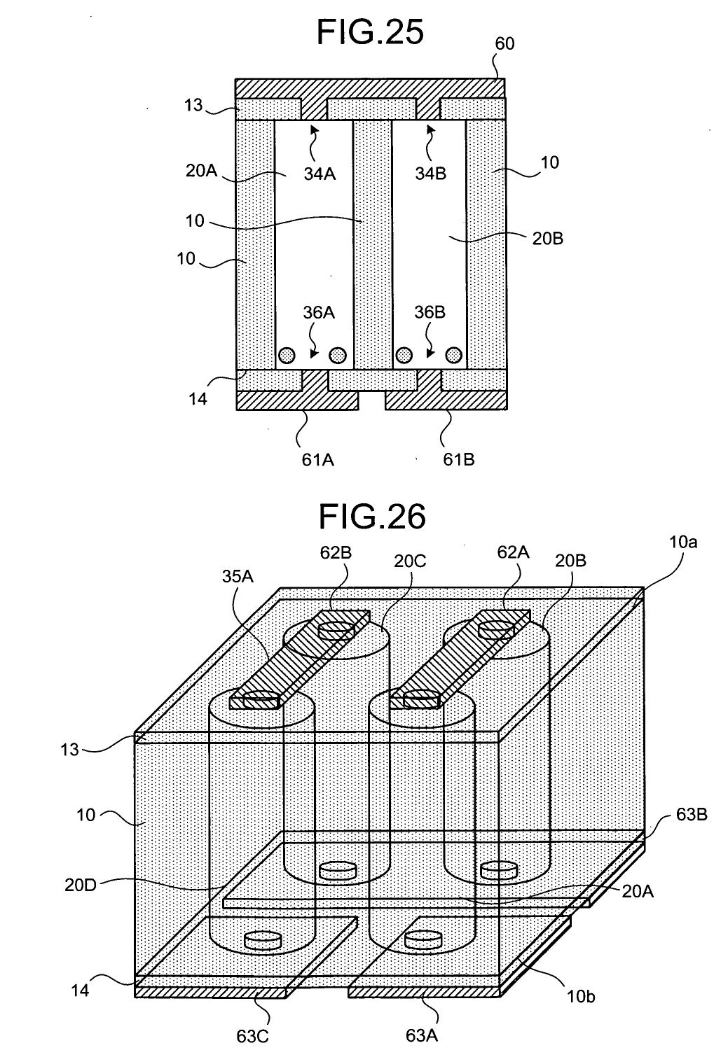

Next, a method of manufacturing the high-pressure discharge light emitting device 600 according to the sixth embodiment is described. FIG. 25 is a vertical sectional view after the etching of the sacrifice layer 21 and the formation of the first conductive diamond layer 60 and the second conductive diamond layer 61. The process up to this state is same with the manufacturing process of the high-pressure discharge light emitting device 300 according to the third embodiment.

Thereafter, the first conductive diamond layer 60 and the second conductive diamond layer 61 are subjected to patterning. Thus, the first conductive diamond layer 60 is left as an integrated connection layer between the first opening 34A and the second opening 34B on the first main surface 10a. On the other hand, the second conductive diamond layer 61 is left in the forms of the first part 61A and the second part 61B of the second conductive diamond layer 61 on the second main surface with a gap between the third opening 36A and the fourth opening 36B. Finally, the polycrystalline translucent diamond substrate 10 is cut into a portion including two discharge spaces. Thus, the high-pressure discharge light emitting device 600 including two discharge spaces can be obtained.

The structure and the method of manufacturing the high-pressure discharge light emitting device 600 according to the sixth embodiment are same with those of the high-pressure light emitting device according to other embodiments in other respect than those specifically described above.

FIG. 26 is a diagrammatical perspective view of the high-pressure light emitting device according to a first modification of the sixth embodiment. The high-pressure discharge light emitting device according to the first modification includes four discharge spaces 20A to 20D. Four discharge spaces 20A to 20D are connected in series. Specifically, the discharge space 20A and the discharge space 20B are connected via a first part 62A of a first conductive diamond layer 62 on the first main surface 10a. Further the discharge space 20B and the discharge space 20C are connected via a second part 63B of a second conductive diamond layer 63 on the second main surface 10b. Further the discharge space 20C and the discharge space 20D are connected via a second part 62B of the first conductive diamond layer 62 on the first main surface 10a.

Thus, with the increase in the number of the discharge spaces 20, the overall power of the entire high-pressure light emitting device can be increased. Further, the plural discharge spaces 20 being arranged in parallel can function as a single light source.

The number of the discharge spaces is not limited to those cited in the embodiment as far as there are plural discharge spaces 20. Further, the arrangement of the plural discharge spaces 20 is not specifically limited as far as the plural discharge spaces 20 are connected in series via the conductive diamond layer. However, the parallel arrangement is preferable to allow for the functioning as the single light source.

Though in the second modification, the high-pressure discharge light emitting device includes the insulating diamond substrate 10 and the conductive diamond layer, the material constituting the substrate and the electrode pair is not limited to those cited in the embodiment. As far as the material allows for enhancement in luminous output through the provision of plural discharge spaces in the substrate, other material such as translucent ceramics can be employed.

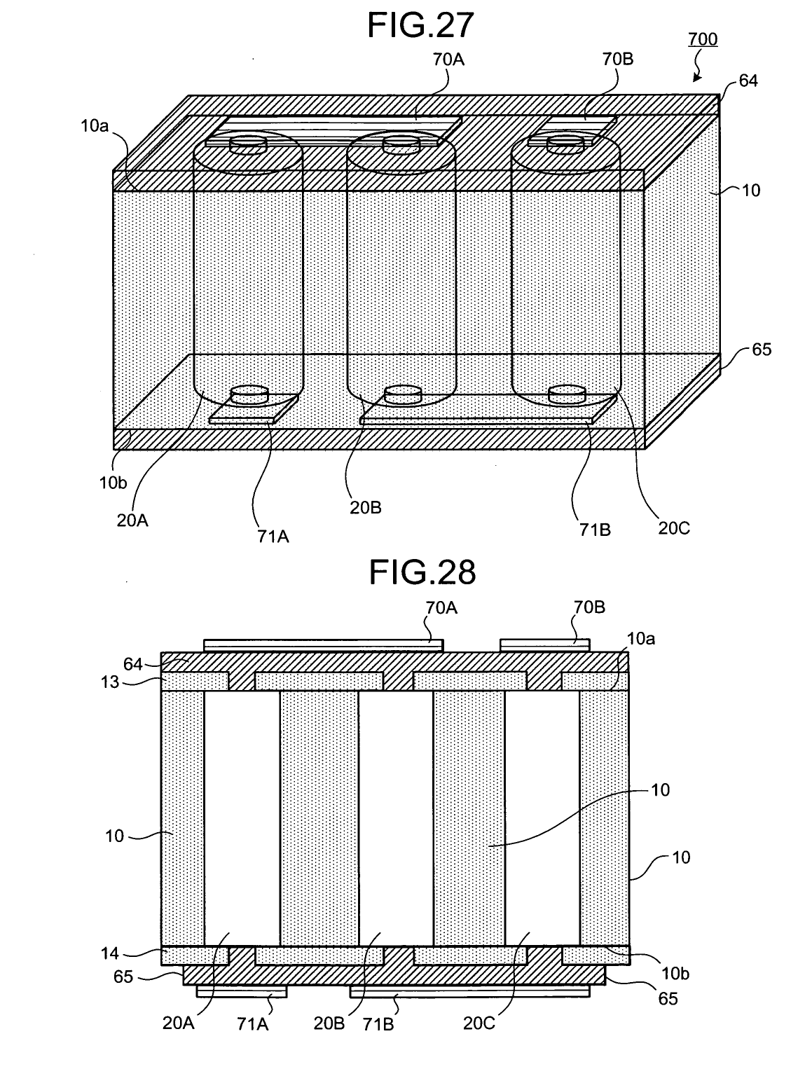

FIG. 27 is a diagrammatic perspective view of a high-pressure discharge light emitting device 700 according to a seventh embodiment. FIG. 28 is a vertical sectional view of the high-pressure discharge light emitting device 700 according to the seventh embodiment. The high-pressure discharge light emitting device 700 according to the seventh embodiment includes three discharge spaces 20A to 20C. Further, the high-pressure discharge light emitting device 1 according to the seventh embodiment includes metal interconnection layers 70A, 70B, 71A, and 71B.

More specifically, in the high-pressure discharge light emitting device 700, a first conductive diamond layer 64 is formed on the first main surface 10a of the insulating diamond substrate 10. Similarly, a second conductive diamond layer 65 is formed on the second main surface 10b of the insulating diamond substrate 10. These layers are provided as the electrode surfaces of the respective discharge spaces 20A to 20C.

The first and the second metal interconnection layers 70A and 70B are further formed on the first conductive diamond layer 64 on the first main surface 10a. Similarly, the third and the fourth metal interconnection layers 71A and 71B are further formed on the second conductive diamond layer 65 on the second main surface 10b. The first and the second metal interconnection layers 70A and 70B on the first main surface 10a and the third and the fourth metal interconnection layers 71A and 71B on the second main surface 10b are all low-resistance wiring formed of metal.

Further, the first conductive diamond layer 64 on the first main surface 10a and the second conductive diamond layer 65 on the second main surface 10b according to the sixth embodiment correspond to a first conductive layer recited in the appended claims. Further, the first and the second metal interconnection layers 70A and 70B on the first main surface 10a and the third and the fourth metal interconnection layer 71A and 71B on the second main surface 10b according to the seventh embodiment correspond to a second conductive layer recited in the appended claims.

The first and the second metal interconnection layers 70A and 70B and the third and the fourth metal interconnection layers 71A and 71B are subjected to patterning so as to connect the discharge spaces 20A to 20C in series. Specifically, the first metal interconnection layer 70A is integrally formed over the region corresponding to the discharge space 20A to the region corresponding to the discharge space 20B so as to connect the discharge space 20A and the discharge space 20B in series. On the other hand, the third metal interconnection layer 71A which is arranged at the side of the second main surface 10b of the discharge space 20A which forms one end of the series, is formed in the region corresponding to the discharge space 20A and separated from the region corresponding to the discharge space 20B.

Further, the fourth metal interconnection layer 71B on the second main surface 10b is integrally formed over the region corresponding to the discharge space 20B to the region corresponding to the discharge space 20C so as to connect the discharge space 20B and the discharge space 20C in series. On the other hand, the second metal interconnection layer 70B arranged at the side of the first main surface 10a of the discharge space 20C which forms one end of the series, is formed in the region corresponding to the discharge space 20C and separated from the region corresponding to the discharge space 20B. In other words, the second metal interconnection layer 70B on the first main surface 10a is separately formed from the first metal interconnection layer 70A on the first main surface 10a.

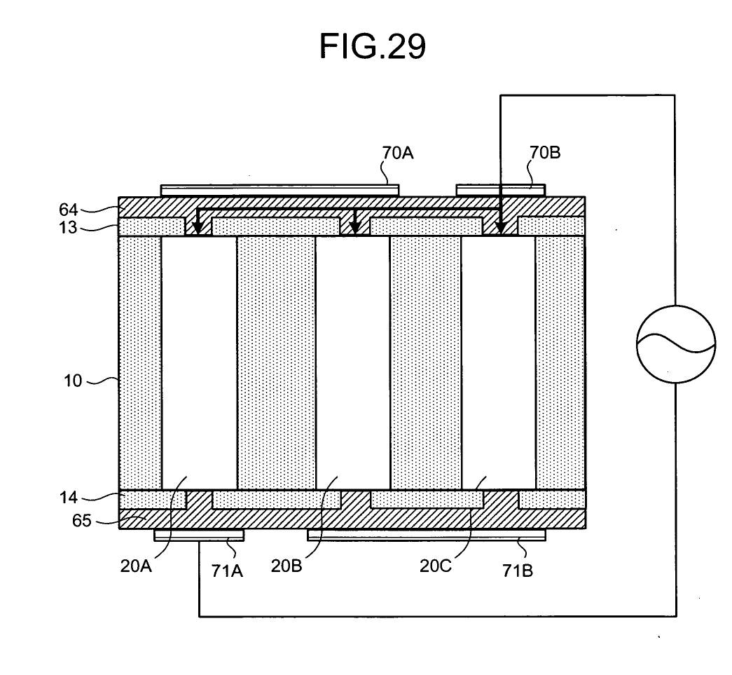

Discharge of the high-pressure discharge light emitting device 700 with the above-described structure is described. FIG. 29 is an explanatory diagram of an initial state of the energization of the high-pressure discharge light emitting device 700. When the high-pressure discharge light emitting device 700 is energized, in the early stage of the energization, the discharge spaces 20A to 20C which are still at low temperature are insulating and exhibit a high resistance value. Hence, voltage is applied uniformed on respective discharge spaces 20A to 20C via the first conductive diamond layer 64 on the first main surface 10a. Thus, the discharge is caused in each discharge space 20A to 20C in parallel.

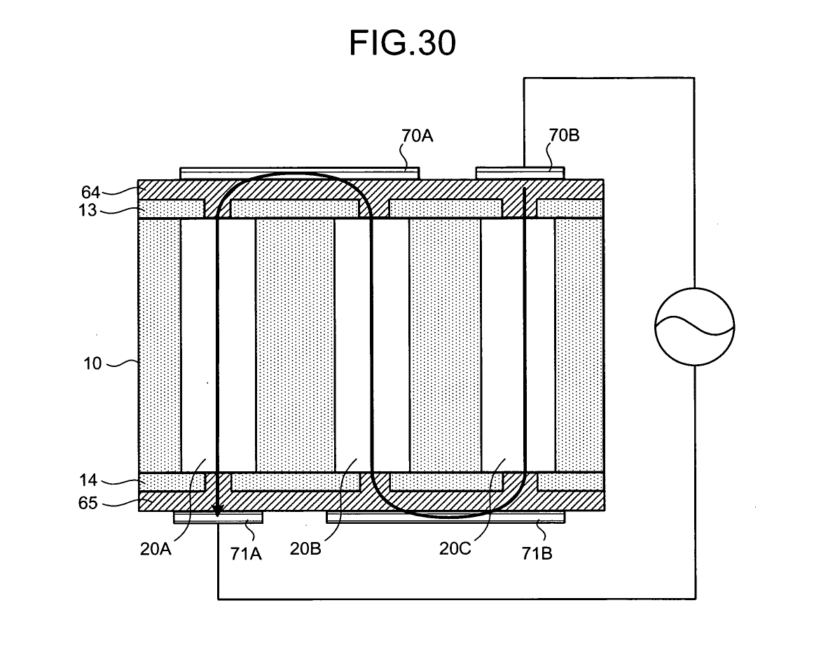

FIG. 30 is an explanatory diagram of a state after the start of discharge. After discharge starts, the voltage drops. Then, with further input of electric current, the state transits from glow discharge mode, abnormal glow state, to arc discharge mode. Thus, the internal resistance of each of the discharge spaces 20A to 20C sharply drops. Then the applied voltage is supplied preferentially to the series-connected circuit via the discharge spaces 20A to 20C.

When the internal resistance of all discharge spaces 20A to 20C drop eventually, the discharge spaces 20A to 20C are collectively driven in the high-pressure discharge light emitting device 700 with the use of the first and the second metal interconnection layers 70A and 70B on the first main surface 10a and the third and the fourth metal interconnection layers 71A and 71B on the second main surface 10b as interconnection.

Then, due to the effect of series connection, regardless of the small interval between the discharge spaces, the discharged voltages of the stages, which are connected in series, are added with each other. Hence, such arrangement can contribute to the maintenance of the discharge voltage. Further, when the device operates simply as a series connected device, the voltage applied at the start of discharge at the energization may increase. In the seventh embodiment, however, the voltage is applied in parallel to all discharge spaces at the start of discharge. Hence, the time required until the start of discharge can also be shortened.

Before the start of discharge, the discharge cell exhibits high resistance inside due to insulating characteristics. Hence, the voltage applied to the first and the second conductive diamond layers 64 and 65 is uniformly applied to the discharge spaces 20A to 20C arranged in parallel.

Once the discharge starts, the resistance inside the discharge spaces 20A to 20C dramatically decreases. Hence, the electric current generated by the voltage applied to the second metal interconnection layer 70B on the first main surface 10a, for example, flows to the second conductive diamond layer 65 via the discharge space 20C.

The electric current flowing from the second metal interconnection layer 70B on the first main surface 10a to the first metal interconnection layer 71A on the second main surface 10b passes through a path where the resistance is minimum. Such path is determined according to a magnitude relation between resistance from the second metal interconnection layer 70B through the first and the second conductive diamond layers 64 and 65 up to the first conductive diamond layer 64 directly below the first metal interconnection layer 70A (hereinafter referred to as inter-parallel-connected cell resistance Rp) and resistance from the second metal interconnection layer 70B, via the discharge space 20C to the fourth metal interconnection layer 71B and via the metal electrode through the discharge space 20B and via the discharge by the discharge space 20B to the first conductive diamond layer 64 (hereinafter referred to as inter-series-connected cell resistance Rs). In other words, when the inter-series-connected cell resistance Rs is lower than the inter-parallel-connected cell resistance Rp, the electric current flows through the path in series-connected mode.

For realization of such an electric current path, the relation Rp>Rs needs to stand at the time of discharge as mentioned above. Here, Rp can be represented by expression (8)
Rp=Rc+R1 (8)
where Rc represents the contact resistance between the electrode and the conductive diamond layer, and R1 represents the sheet resistance of the conductive diamond layer between the discharge spaces arranged parallel with each other.

Further, Rs can be represented by expression (9):
Rs=Rc×3+Rd×3+Rh×2+Rm (9)
where Rd represents the resistance of the conductive diamond layer in the thickness direction from directly below the electrode to the discharge space, Rh represents the resistance in the discharge space, and Rm represents sheet resistance of the electrode layer between the discharge spaces arranged parallel with each other. Here, “Rd×3” is set in consideration of the number of turns at the side of the second conductive diamond layer 65.

Here, expression (10) stands, which indicates that Rh and Rm are relatively smaller than other right-hand terms in expression (9) of Rs:
Rs≈3Rc+3Rd (10)

Hence, Rp>Rs can be represented by expression (11) according to expressions (8) and (10):
Rc+R1>3Rc+3Rd (11)
Based on expression (11), a relation represented by expression (12) can be obtained:
R1>2Rc+3Rd (12)

Here, expressions (13) and (14) holds where ρ represents the resistance of the conductive diamond layer.
R1≈ρ×1/(w×d) (13)
Rd≈ρ×1/s (14)
where 1 represents an interval between cells, w represents an effective interconnection width of the conductive diamond layer, d represents a thickness of the conductive diamond layer, and s represents an effective interconnection area of the conductive diamond layer.

Here, Rc is relatively smaller than Rd, and expression (15) can be obtained from expression (12).
R1>3Rd (15)
When R1 and Rd in expression (15) are substituted for by expressions (13) and (14), expression (16) is obtained:
1/(w×d)>3(d/s) (16)
Further, expression (17) is obtained:
1>3(d/s)×(w×d)=3 w×d²/s (17)
Thus, the condition for the realization of the electric current path is to establish the relation represented by expression (17).

The temperature of the conductive diamond layer rises immediately after the start of discharge. Along with temperature rise, the value of ρ changes, though the change does not affect the above relation due to offsetting. Hence, with the design which satisfies the above condition, an operation mode can be designed without dependency on the resistivity.

Boron (B) is desirably employed as added impurity since boron exhibits conductivity at temperature as low as room temperature. Alternatively, nitrogen (N) or phosphorous (P) may be employed since these exhibit conductivity as temperature rises. In either case, dopant concentration is desirably in the range of 1×10¹⁸ to 1×10²¹ cm⁻³.

The structure and the method of manufacturing the high-pressure discharge light emitting device 700 according to the seventh embodiment are same with those of the high-pressure discharge light emitting device according to other embodiments in other respects than those specifically described above.

In the seventh embodiment, the conductive diamond layer and the metal interconnection layer are formed from diamond and metal as can be seen. However, as a first modification, these layers may be formed from any materials as far as two materials with different conductivity are employed to form the layer structure, and the materials to be employed are not limited to those employed in the seventh embodiment.

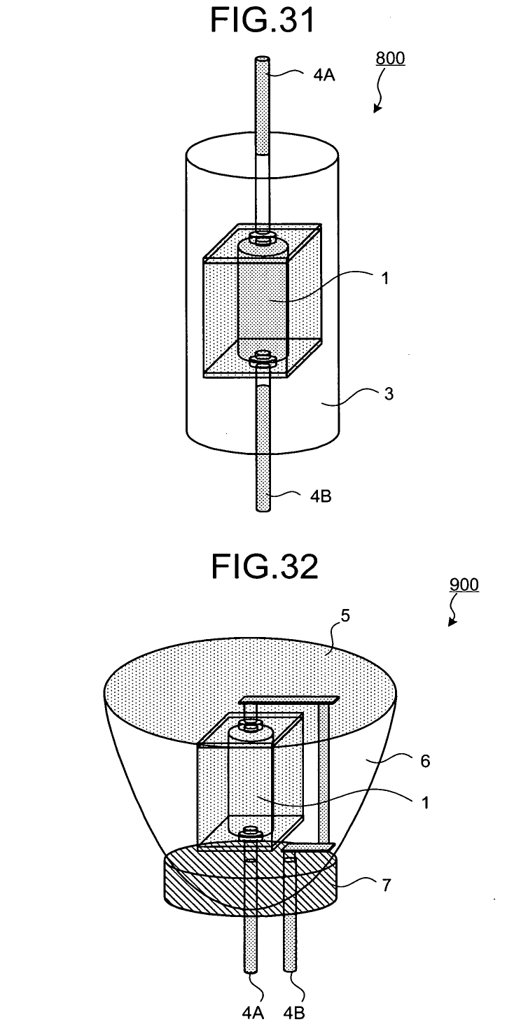

FIG. 31 is a diagrammatic perspective view of a light emitting apparatus 800 according to an eighth embodiment. The light emitting apparatus 800 according to the eighth embodiment incorporates the high-pressure discharge light emitting device 100 according to the first embodiment. Electrodes of the high-pressure discharge light emitting device 100 are connected to external leads 4A and 4B, respectively. The high-pressure discharge light emitting device 100 is maintained in a vacuum state. In other words, an interior of a container 3 is maintained in vacuum. The high-pressure discharge light emitting device 100 is held in the interior of the container 3. Further, the high-pressure discharge light emitting device 100 is sealed in the container 3. Conventional mounting method for the HID lamp can be applied to the sealing of the container 3. Here, the high-pressure discharge light emitting device according to other embodiments may be mounted. For example, a high-pressure discharge light emitting device which includes a plurality of discharge spaces 20 as the high-pressure discharge light emitting device 600 according to the sixth embodiment may be mounted.

Alternatively, inactive gas such as rare gas may be filled into the container 3 and maintained in a reduced pressure which is lower than the atmospheric pressure. When the inactive gas is filled and maintained at a reduced pressure, an external pressure applied on a diaphragm of the discharge space can be reduced. Further, the rupture of the container 3 due to the internal pressure can be prevented.

FIG. 32 is a diagrammatic perspective view of a light emitting apparatus 900 according to a ninth embodiment. The light emitting apparatus 900 according to the ninth embodiment incorporates the high-pressure discharge light emitting device 100 according to the first embodiment. The light emitting apparatus 900 includes a transparent glass window 5, a reflecting mirror 6, and a stem 7 which supports the reflecting mirror 6 and the high-pressure discharge light emitting device 100, and is capable of efficiently radiate light from the transparent glass window 5. Here, the high-pressure discharge light emitting device according to other embodiments may be mounted.

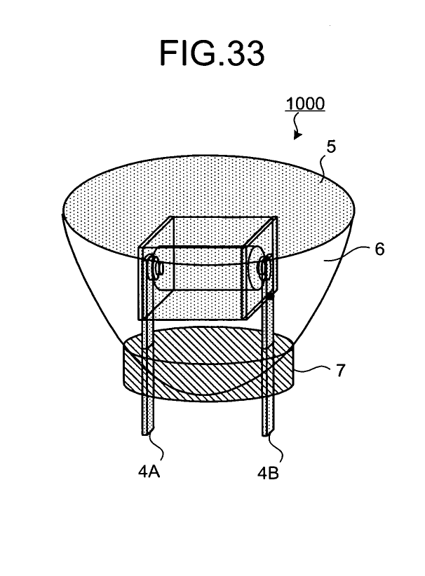

FIG. 33 is a diagrammatic perspective view of a light emitting apparatus 1000 according to a tenth embodiment. The light emitting apparatus 1000 according to the tenth embodiment incorporates the high-pressure discharge light emitting device 100 so that a direction of discharge by the high-pressure discharge light emitting device 100 is parallel with an in-plane direction of the transparent glass window 5. Here, the high-pressure discharge light emitting device according to other embodiments may be mounted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A discharge light emitting device comprising:
a container formed from insulating diamond and accommodating a discharge space therein;
a material for discharge sealed in the discharge space; and
an electrode pair formed from conductive diamond and provided to apply voltage to the material for discharge.

2. The discharge light emitting device according to claim 1, wherein
the conductive diamond is diamond doped with impurity.

3. The discharge light emitting device according to claim 2, wherein
the impurity is one of elements consisting of phosphorous, nitrogen, boron, and sulfur.

4. The discharge light emitting device according to claim 1, wherein the material for discharge is one of materials consisting of metal halide, mercury, sulfur, zinc, and compound thereof.

5. The discharge light emitting device according to claim 1, wherein
the electrode pair is formed in a protruding shape inside the discharge space.

6. A discharge light emitting device, comprising:
a translucent container in which a plurality of discharge spaces are arranged;
a material for discharge sealed in each of the plurality of discharge spaces; and
a plurality of electrode pairs each of which applies voltage to one of the plurality of discharge spaces.

7. The discharge light emitting device according to claim 6, wherein
the plurality of discharge spaces are connected in series.

8. The discharge light emitting device according to claim 6, wherein
the plurality of discharge spaces are arranged parallel with each other in a direction which is substantially perpendicular to a direction of electric current flow.

9. The discharge light emitting device according to claim 6, wherein
the container is formed from insulating diamond.

10. The discharge light emitting device according to claim 6, wherein
the electrode pair is formed from conductive diamond.

11. A discharge light emitting device comprising:
a translucent container including a first low conductive layer and a second low conductive layer arranged as to face with each other, and a plurality of discharge spaces arranged between the first low conductive layer and the second low conductive layer;
a material for discharge sealed in each of the plurality of discharge spaces; and
a plurality of electrode pairs which apply voltage to the plurality of discharge spaces, respectively, and each includes a high conductive layer which exhibits a higher conductivity than the first low conductive layer and the second low conductive layer and is formed at a position where two of the plurality of discharge spaces are connected in series at least in a region of one of the first low conductive layer and the second low conductive layer.

12. The discharge light emitting device according to claim 11, wherein
the plurality of discharge spaces are arranged in parallel in a direction substantially perpendicular to a direction of electric current flow.

13. The discharge light emitting device according to claim 11, wherein
the container is formed from insulating diamond.

14. The discharge light emitting device according to claim 11, wherein
the electrode pair is formed from conductive diamond.

15. A light emitting apparatus comprising:
the discharge light emitting device according to claim 1; and
a container accommodating the discharge light emitting device inside.

16. A light emitting apparatus comprising:
the discharge light emitting device according to claim 6; and
a container accommodating the discharge light emitting device inside.

17. A light emitting apparatus comprising:
the discharge light emitting device according to claim 11; and
a container accommodating the discharge light emitting device inside.

18. A method of manufacturing a light emitting device comprising:
forming a plurality of penetrating holes which penetrate a first main surface and a second main surface of an insulating layer;
filling the plurality of penetrating holes with a sacrifice layer;
forming an electrode forming layer on each of the first main surface and the second main surface of the insulating layer in which the sacrifice layer is formed;
forming an opening in a region corresponding to the sacrifice layer in the electrode forming layer formed on each of the first main surface and the second main surface;
removing the sacrifice layer via the opening;
sealing the opening after the removal of the sacrifice layer by formation of a conductive layer on the electrode forming layer, to form a discharge space which utilizes the conductive layer as electrode; and
cutting a formed layered structure into a unit including the discharge space after the formation of the discharge space, to obtain the light emitting device.

19. The method of manufacturing the light emitting device according to claim 18, wherein
the electrode forming layer is formed from conductive material.

20. The method of manufacturing the light emitting device according to claim 19,.wherein
the conductive material is conductive diamond.

21. The method of manufacturing the light emitting device according to claim 18, wherein
the electrode forming layer is formed from insulating material.

22. The method of manufacturing the light emitting device according to claim 21, wherein
the insulating material is insulating diamond.

23. The method of manufacturing the light emitting device according to claim 18, wherein
the conductive layer is formed from conductive diamond.

24. The method of manufacturing the light emitting device according to claim 18, further comprising:
removing the conductive layer stacked in a region outside the region corresponding to the opening in the electrode forming layer after the sealing of the opening; and
cutting the formed layered structure into a unit of discharge space after the removal of the conductive layer.
